(19) United States
(12) Patent Application Publication
(10) Pub. No.: US 2012/0273633 A1
(43) Pub. Date: Nov. 1, 2012

(54) TWO PIECE TRACK ASSEMBLY

(75) Inventors: Jay M. Henriott, Jasper, IN (US); Keith E. Metcalf, Jasper, IN (US)

(73) Assignee: KIMBALL INTERNATIONAL, INC., Jasper, IN (US)

(21) Appl. No.: 13/454,228

(22) Filed: Apr. 24, 2012

Related U.S. Application Data
(60) Provisional application No. 61/479,022, filed on Apr. 26, 2011.

(51) Int. Cl. A47B 96/06; B23P 11/00

(52) U.S. Cl. 248/205.1; 248/309.1; 29/428

(57) ABSTRACT

A two-piece track assembly may be used in an office environment for mounting accessory components, such as work surfaces, cabinets, shelves, filing units, etc., to either a permanent building wall or to the framework of a movable office wall or office partition system. The track assembly includes a base mountable to the wall or framework via a plurality of fasteners. A track mounts to the base to cover the fasteners used to mount the base. The track also includes a relatively thinly-profiled slot into which a corresponding, relatively thinly-profiled mounting flange of an accessory component is received to mount and support the accessory component upon the track assembly. Optionally, a decorative or functional tile may be mounted to a wall or partition between a pair of track assemblies spaced vertically from one another.

### CROSS REFERENCE TO RELATED APPLICATION

This application claims the benefit under Title 35, U.S.C. §119(e) of U.S. Provisional Patent Application Ser. No. 61/479,022, entitled TWO PIECE TRACK ASSEMBLY, filed on Apr. 26, 2011, the entire disclosure of which is expressly incorporated by reference herein.

### BACKGROUND

1. Technical Field

The present disclosure relates to office furniture, and in particular to an accessory track for mounting accessory office furniture components to a permanent wall or to panels of a partition system.

2. Description of the Related Art

In an office environment, tracks are used to mount accessory components, such as work surfaces, cabinets, shelves, filing units, etc., to either a permanent wall or to the walls of an office partition system. One known track is formed as a single piece extrusion having a channel which is relatively wide in a vertical dimension. Brackets or other mounting hardware are used to mount an accessory component to the track, with the brackets or hardware separate from both the track and the accessory component.

Although the foregoing tracks have proven useful, improvements to the same are desired.

### SUMMARY

The present disclosure provides a two-piece track assembly that may be used in an office environment for mounting accessory components, such as work surfaces, cabinets, shelves, filing units, etc., to either a permanent building wall or to the framework of a movable office wall or office partition system. The track assembly includes a base mountable to the wall or framework via a plurality of fasteners. A track mounts to the base to cover the fasteners used to mount the base. The track also includes a relatively thinly-profiled slot into which a corresponding, relatively thinly-profiled mounting flange of an accessory component is received to mount and support the accessory component upon the track assembly. Optionally, a decorative or functional tile may be mounted to a wall or partition between a pair of track assemblies spaced vertically from one another.

In one form thereof, the present disclosure provides a track assembly, comprising: a first component mountable to a substrate, the first component comprising: an exterior face; an upper portion including upper engagement structure; and a lower portion including lower engagement structure; and a second component mountable to the first component, the second component comprising: a body having a front body portion and a rear body portion; the front body portion including a slot having a first, horizontal slot section extending into the body from a front face of the front body portion and a second, angled slot section extending into the body from the first slot section; and the rear body portion including an upper arm and a lower arm, the upper and lower arms respectively engageable with the upper and lower engagement structures of the first component.

In another form thereof, the present disclosure provides, in combination, an accessory component comprising a mounting flange including a first, horizontal flange portion and a second, angled flange portion extending from the first flange portion; and a track assembly, comprising: a first component mountable to a vertical substrate, the first component comprising: an exterior face; an upper portion including an upper engagement structure; and a lower portion including a lower engagement structure; and a second component mountable to the first component, the second component comprising: a body having a front body portion and a rear body portion; the front body portion including a slot having a first, horizontal slot section extending into the body from a front face of the front body portion and a second, angled slot section extending into the body from the first slot section, the slot sized to receive the mounting flange; and the rear body portion including an upper arm and a lower arm, the first component mounted to the second component when the upper arm and the lower arm are engaged with the upper and lower engagement structures of the first component, respectively.

In yet another form thereof, the present disclosure provides a method of mounting a track assembly to a vertical substrate of an office system, comprising the steps of: providing a track assembly comprising a first component and a second component; mounting the first component to the vertical substrate; and pivotally mounting the second component to the first component.

### BRIEF DESCRIPTION OF THE DRAWINGS

The above-mentioned and other features and advantages of this disclosure, and the manner of attaining them, will become more apparent and the invention itself will be better understood by reference to the following descriptions of embodiments of the invention taken in conjunction with the accompanying drawings, wherein:

FIG. 1 is perspective view of a two piece wall track assembly of the present disclosure, illustrating a base of the track assembly attached to a wall, a track of the track assembly mounted to the base, and an accessory component mounted to the track via a mounting flange received in a slot of the track, and a pair of tiles coupled to the track;

FIG. 2A is an elevation, cross-sectional view of a base of the track assembly shown in FIG. 1, in which the base portion is mounted to a substrate surface;

FIG. 2B is an elevation, cross-sectional view of a track of the track assembly shown in FIG. 1

FIG. 2C is an elevation, cross-sectional view of the track of FIG. 2B mounted to the base of FIG. 2A to form the track assembly of FIG. 1;

FIG. 2D is an elevation, cross-sectional view of the track assembly of FIG. 2C, in combination with a pair of tiles coupled to the track;

FIG. 2E is an elevation, cross-sectional view of the combination of FIG. 2D, further in combination with an accessory component mountable to the track;

FIG. 3A is a partial elevation, cross-sectional view of the assembly of FIG. 1, in which the base is mounted to a wall and the track is shown being initially mounted to the base, such that an upper arm of a rear body portion of the track engages an upper engagement structure of the base;

FIG. 3B is a continuation of FIG. 3A, showing the track pivoted about the upper arm to urge a lower arm of the rear body portion of the track towards a lower engagement structure of the base;

FIG. 3C is a continuation of FIG. 3B, showing the lower arm of the track urged further toward the lower engagement structure of the base;

FIG. 3D is a continuation of FIG. 3C, showing the track fully mounted to the base, such that the upper and lower arms of the track are respectively engaged with the upper and lower engagement structures of the base;

FIG. 4A is an elevation, cross-sectional view of the assembly of FIG. 1, in which the accessory component is shown in a pre-mounting position in which the accessory component is angled with respect to the track assembly;

FIG. 4B is a continuation of FIG. 4A, showing the accessory component mounted to the track assembly in a mounted position in which a mounting flange of the accessory component is fully seated within a slot of the track of the track assembly, and the accessory component is disposed in a vertical upright position;

FIG. 5 is a perspective view of a portion of the accessory component of FIG. 1; and

FIG. 6 is an elevation, cross-sectional view of a pair of tracks fastened to a wall in vertically spaced relation, schematically illustrating the mounting of a tile between mutually-facing tile-receiving channels formed in the pair of tracks.

Corresponding reference characters indicate corresponding parts throughout the several views. The exemplifications set out herein illustrate exemplary embodiments of the invention, and such exemplifications are not to be construed as limiting the scope of the disclosure in any manner.

### DETAILED DESCRIPTION

Accessory components, such as work surfaces, cabinets, shelves, filing units, etc. are often used in office environments. The present disclosure describes a two-piece track assembly that may be used in an office environment for modular mounting of such accessory components to either a permanent building wall or to the framework of a movable office wall or office partition system. The track assembly of the present disclosure includes a base mountable to the wall or framework via a plurality of fasteners, and a track mountable to the base such that the fasteners used to mount the base are covered.

The track also includes a relatively thinly-profiled slot sized to receive a corresponding, relatively thinly-profiled mounting flange of an accessory component (as described herein). When so received, the flange and slot cooperate to mount and support the accessory component upon the track assembly. Optionally, the track assemblies may be mounted as vertically spaced pairs adapted to receive a decorative or functional tile therebetween, such that the tile covers the adjacent wall or partition.

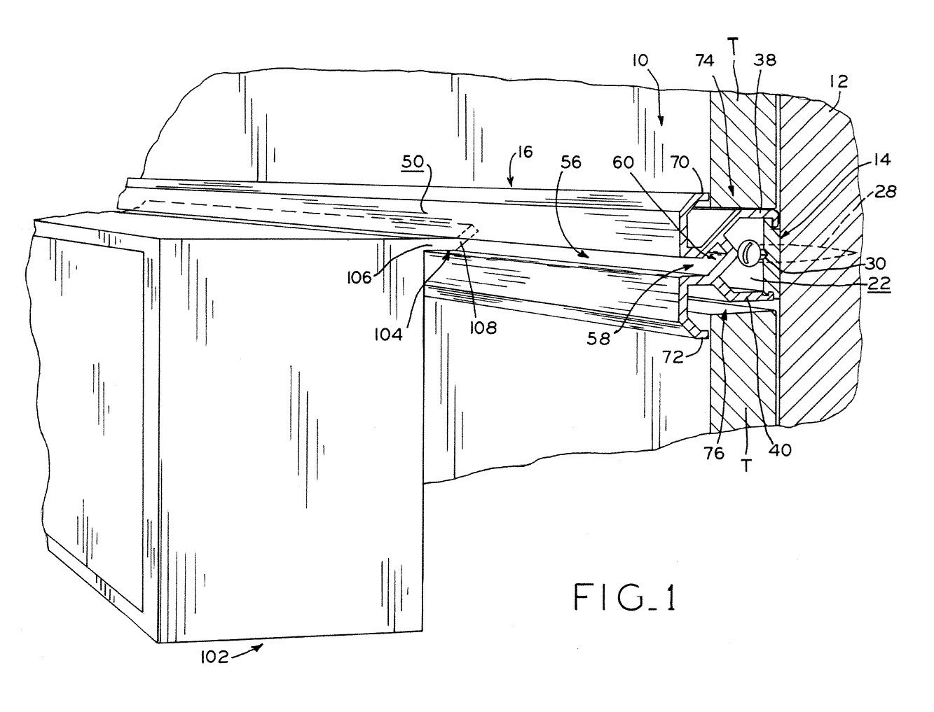

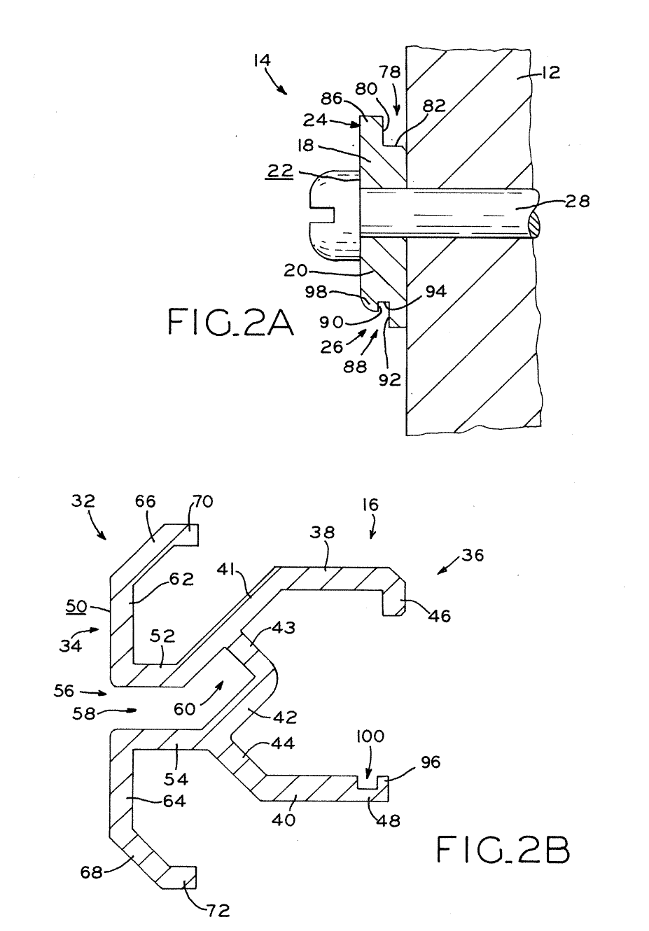

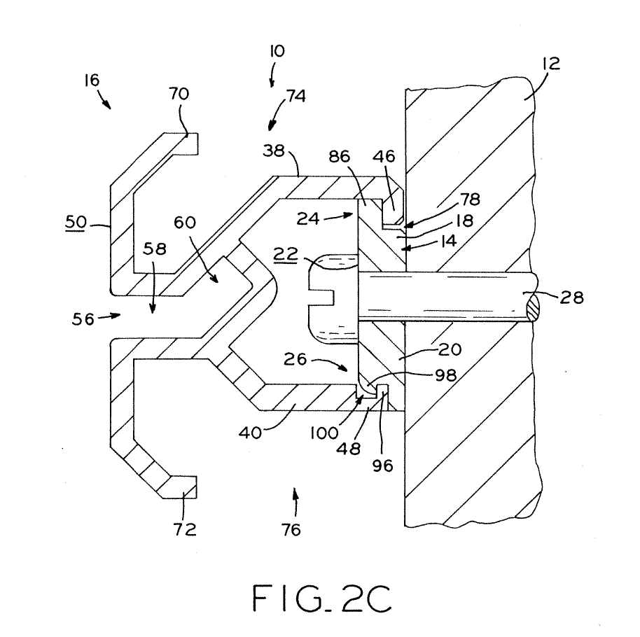

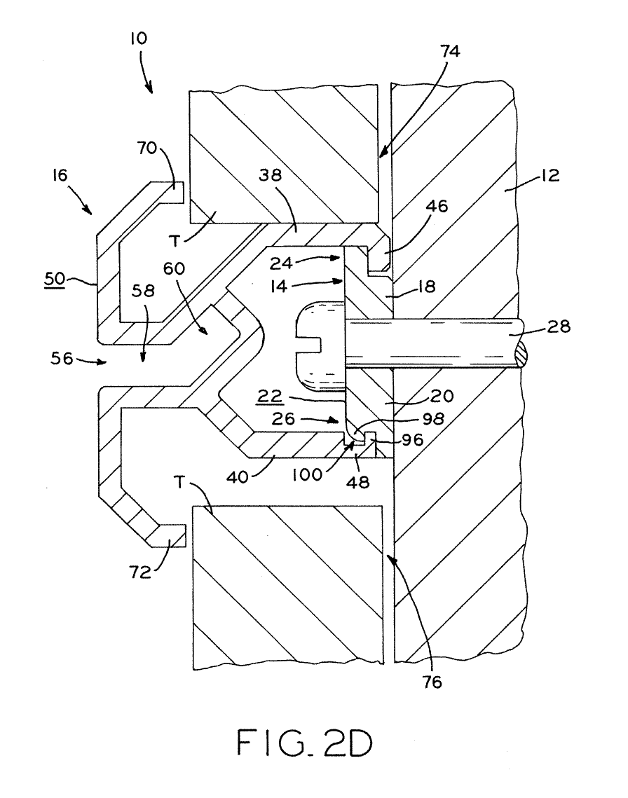

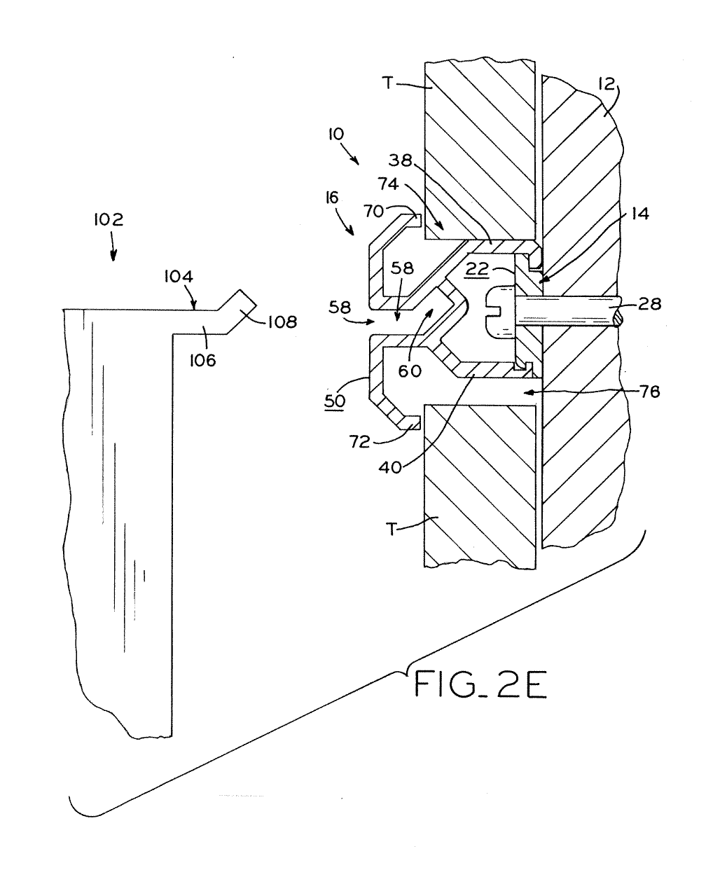

Referring now to FIGS. 1 and 2, two-piece wall track assembly 10 is shown mounted upon substrate surface 12, which may be any substrate surface capable of providing support for track assembly 10. Exemplary substrate surfaces 12 suitable for use with track assembly 10 include permanent interior or exterior walls of a building, movable office walls such as floor-to-ceiling partition systems, and movable partition system panels of the type that do not extend completely from a floor to a ceiling.

Two-piece track assembly 10 includes a first component, shown as base 14, and a second component, shown as track 16. As illustrated in FIG. 2A, when mounted to a vertically oriented substrate surface 12, base 14 includes a vertically oriented wall having upper portion 18 and lower portion 20 (FIG. 2A). Exterior or front face 22 of base 14 spans upper and lower portions 18 and 20 of base 14 and faces away from substrate 12 when base 14 is attached thereto as shown. Upper and lower portions 18 and 20, of the base 14 include respective upper and lower engagement structures 24, 26 respectively which cooperate with corresponding structures of track 16 to form assembly 10 as described in detail below. Base 14 is attached to substrate 12 using a plurality of fasteners 28, for example, which may be driven through a V-shaped locating indent feature 30 (FIG. 1) formed on exterior face 22 of base 14.

Turning now to FIG. 2B, track 16 is mountable to base 14 (as shown in FIG. 2C) and includes body 32 having front body portion 34 and rear body portion 36. Rear body portion 36 includes upper arm 38 and lower arm 40 with a plurality of inner angled walls 41, 42, 43, 44 disposed between upper arm 38 and lower arm 40. In an alternative embodiment, the walls disposed between upper and lower arms 38 and 40, respectively, may be perpendicular to, rather than acutely angled with respect to, upper and lower arms 38 and 40. Upper and lower arms 38 and 40 are oriented horizontally and each include respective engagement portions 46 and 48 for engagement with respective upper and lower engagement structures 24 and 26 of base 14. Thus, as described in detail below, upper arm 38 of track 16 is connectable to upper portion 18 of the vertically oriented base 14 and lower arm 40 of track 16 is connectable to lower portion 20 of base 14. When so connected, base 14 and track 16 combine to form track assembly 10.

As shown in FIG. 2C, exterior or front face 50 of front body portion 34 of track 16 substantially covers and restricts access to base 14 when track 16 is mounted to base 14. More particularly, rear body portion 36 of track 16 (i.e., the plurality of inner angled walls 41, 42, 43, 44 and horizontal upper and lower arms 38 and 40, as shown in FIG. 2B) restricts access to exterior face 22 of base 14 when track 16 is mounted to base 14.

Turning back to FIG. 2B, track 16 further includes a first, upper inner horizontal wall 52 and second, lower inner horizontal wall 54 that each extend forward from one or more of the plurality of inner angled walls 41, 42, 43, 44. Walls 41, 42, 43, 52, and 54 together define a relatively narrow channel or slot 56 extending inwardly and generally rearward into front body portion 34 from front face 50 of track 16. Slot 56 includes a horizontally oriented slot section 58 adjacent to front face 50, with slot section 58 formed by horizontal walls 52 and 54. Slot 56 further includes a second, upwardly angled slot section 60 extending rearward from slot section 58, with angled slot section formed by inner angled walls 41 and 42 which are parallel to one another.

Front body portion 34 of track 16 includes a pair of vertical walls 62 and 64 that extend in opposite directions from slot 56 and cooperate to define front face 50 of track 16. More particularly, each vertical wall 62 and 64 extends from a respective one of the first and second inner horizontal walls 52 and 54, which in turn project forwardly from the plurality of inner angled walls as described above. Front body portion 34 of track 16 additionally includes a pair of outer angled walls 66 and 68 that are angled with respect to substrate 12 and respectively extend rearward from vertical walls 62 and 64. Upper and lower extensions 70 and 72 each extend rearward from a respective one of the pair of the outer angled walls 66 and 68 toward substrate 12. As described below, extensions 70 and 72 may form a pair of tile-receiving horizontal flanges capable of supporting tiles T (FIGS. 1, 2D and 2E).

As illustrated FIG. 2C, upper tile-receiving horizontal extension 70 cooperates with upper horizontal arm 38 of track 16 and substrate 12 to define upper tile receiving space 74. Similarly, lower tile-receiving horizontal extension 72 cooperates with lower horizontal arm 40 of track 16 and substrate 12 to define lower tile receiving space 76. A portion of a pair of tiles T are shown received in upper and lower tile receiving spaces 74, 76 in FIG. 2D. The manner in which tiles T are inserted into tile receiving spaces 74 and 76 is illustrated in FIG. 6 and described in detail below.

Upper portion 18 of base 14 includes an upper protrusion 86 (FIG. 2A) defining vertical and horizontal walls 80 and 82. Walls 80 and 82 cooperate with an adjacent surface of substrate 12 to form upper notch 78, which is configured to receive engagement portion 46 of track 16 (FIG. 2B) in a mounting engagement as shown in FIG. 2C. Engagement portion 46 is sized to occupy less than the entire vertical space defined by notch 78, such that upper protrusion 86 abuts a bottom surface of upper arm 38 of track 16 when engagement portion 46 is placed in such mounting engagement with notch 78.

Turning again to FIG. 2A, lower portion 20 of base 14 includes lower intermediate notch 88 defined by a pair of internal vertical walls 90 and 92 and an internal horizontal wall 94. Wall 90 is forward of wall 92, i.e., wall 90 is spaced further away from substrate 12 than is wall 92. Wall 90 is shorter in length compared to wall 92 to facilitate a snap-fit engagement with lower arm 40 as described below. Lower arm 40 of track 16, shown in FIG. 2B, includes second vertical flange 96 that projects upwardly and is sized and configured to be received in lower intermediate notch 88 of base 14. Particularly, lower intermediate notch 88 of base 14 is configured to receive second vertical flange 96 of track 16 to engage track 16 with base 14, as described in detail below.

Lower portion 20 of base 14 further includes lower protrusion 98 (FIG. 2A) adjacent lower intermediate notch 88. Lower notch 100 (FIG. 2B) is formed in lower arm 40 of track 16 adjacent second vertical flange 96, and is configured to receive lower protrusion 98 of base 14 when track 16 is mounted and engaged to base 14 as described below.

Referring to FIGS. 1, 2E and 5, accessory component 102 includes mounting flange 104 sized to be received within slot 56 of track 16, as described in detail below. Mounting flange 104 includes a first, horizontal flange portion 106 and a second, angled flange portion 108. Angled slot section 60 of slot 56 of track 16 is sized and configured to receive angled flange portion 108 of mounting flange 104, while horizontal slot section 58 of slot 56 of track 16 is sized and configured to receive horizontal flange portion 106 of mounting flange 104.

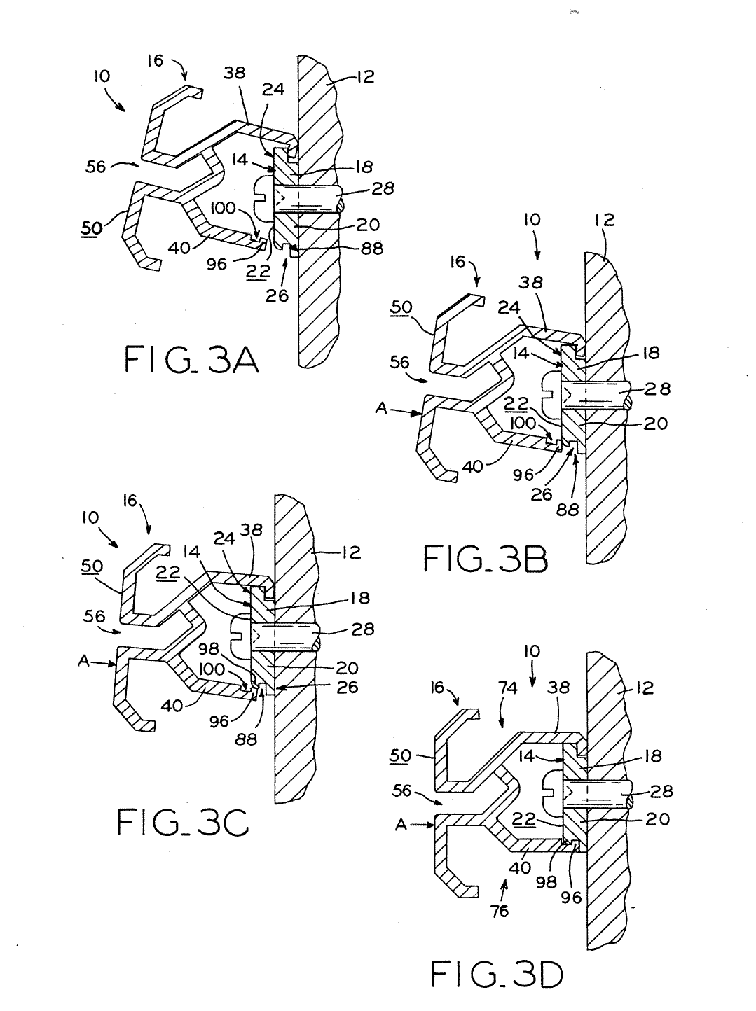

The manner and method of mounting track 16 to base 14 is shown in FIGS. 3A-3D and described below. As noted above and shown in FIG. 1, base 14 is first mounted to substrate 12 by one or more fasteners 28, which are inserted through the outwardly facing V-shaped notch 30 formed in front face 22 of base 14. With base 14 securely mounted to substrate 12, upper arm 38 of track 16 is initially engaged with upper portion 18 of base 14 (as shown in FIG. 3A and described below) prior to rotating track 16 downwardly to engage lower arm 40 of track 16 with lower portion 20 of base 14. However, the reverse order may also be possible. For example, it is contemplated that lower arm 40 of track 16 may be initially engaged with lower portion 20 of base 14, such that track 16 is rotated upwardly to engage upper arm 38 of track 16 with upper portion 18 of base 14. Yet another contemplated alternative is for both upper horizontal arm 38 and lower horizontal arm 40 of track 16 to be simultaneously engaged with respective upper and lower portions 18 and 20 of the base 14.

Referring back to FIG. 3A, upper horizontal arm 38 of track 16 is shown as being initially engaged with upper portion 18 of base 14 (i.e., by engaging upper engagement portion 46 of track 16 into notch 78 of base 14, as shown in FIG. 2C and described above). Turning to FIG. 3B track 16 is rotated in the direction of arrow A toward base 14 such that lower horizontal arm 40 of track 16 is urged toward lower portion 20 of base 14. As described above and shown in FIG. 2A, lower portion 20 of base 14 has internal vertical wall 90 that is spaced forward of, and shortened with respect to, wall 92. This arrangement allows vertical flange 96 of lower horizontal arm 40 of track 16 to clear protrusion 98 of base 14 as track 16 is rotated along direction A into the final mounted position, as shown between FIGS. 3C and 3D.

When track 16 is in a position of near-final engagement with respect to base 14, as shown in FIG. 3C, lower arm 40 and/or upper arm 38 of track 16 may slightly resiliently deform or bend in order to traverse lower protrusion 98. This resilient material deformation allows arms 38, 40 to “snap” back into their undeformed, parallel and horizontal state, as shown in FIG. 3D, when protrusion 98 is received within lower notch 88 (FIG. 2C) of base 14.

Track 16 is fully mounted to base 14 when lower horizontal arm 40 is fully engaged with lower portion 20 of base 14. More particularly, second vertical flange 96 of lower horizontal arm 40 of track 16 is received in snap-fit engagement within lower intermediate notch 88 of lower portion 20 of base 14, and lower protrusion 98 of lower portion 20 of base 14 is received within notch 100 of lower horizontal arm 40 of track 16.

Thus, track 16 is pivotally mountable to base 14 such that upper arm 38 of track 16 pivots about upper portion 18 of base 14 until lower arm 40 of track 16 attaches to lower portion 20 of base 14 in a snap-fit connection. When track 16 is mounted to base 14, front face 50 of track 16 substantially covers front face 22 of base 14 and thereby hides fasteners 28 from view.

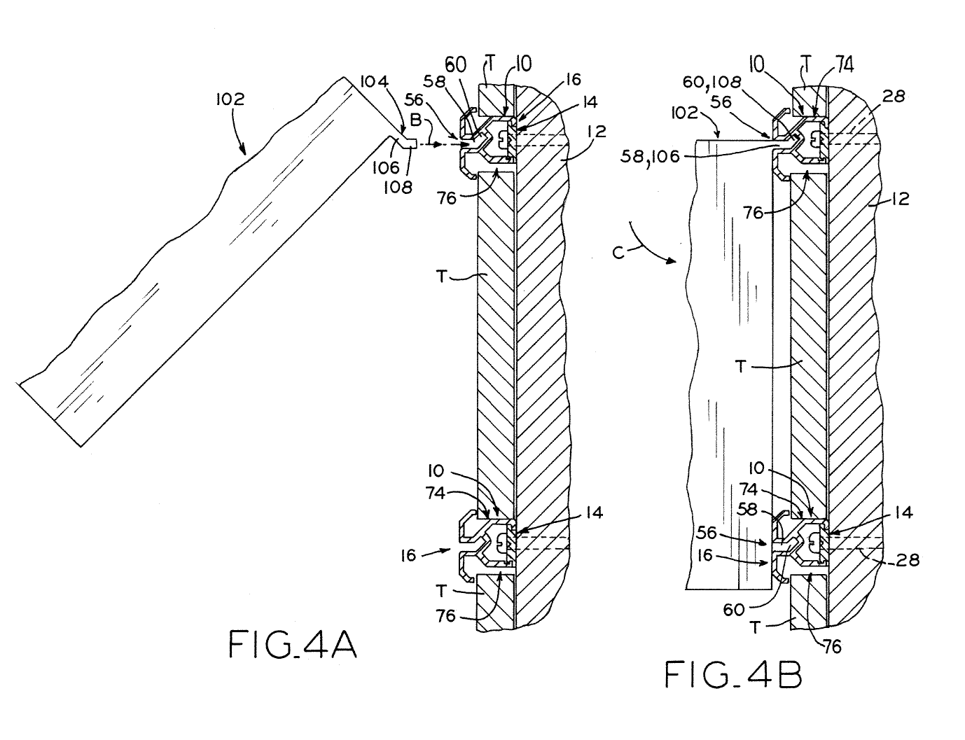

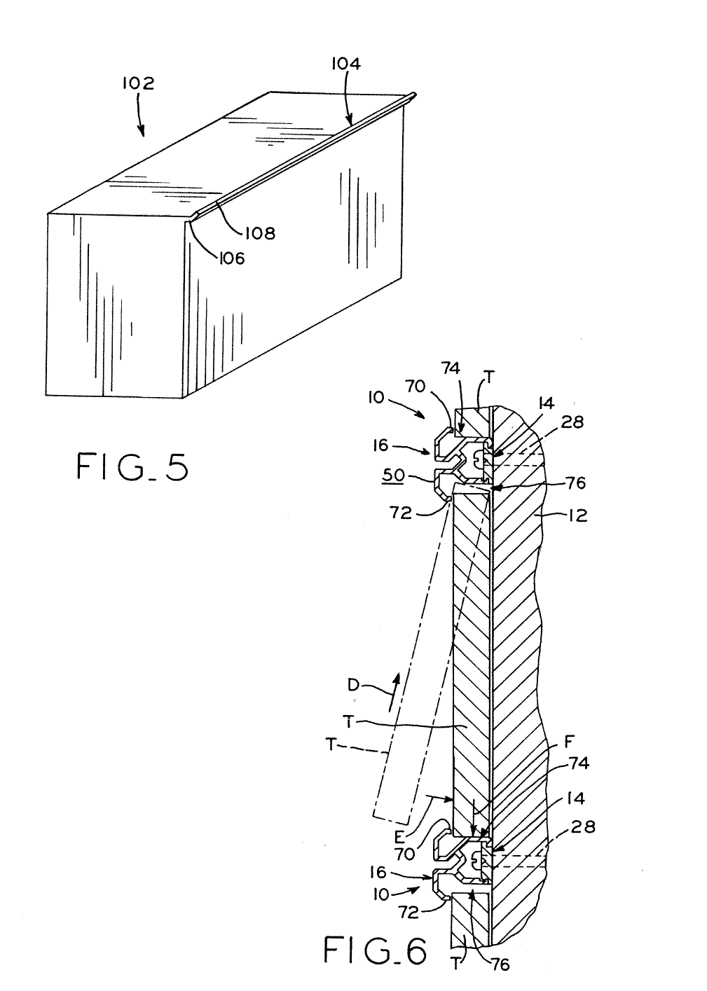

Turning now to FIGS. 4A and 4B, an accessory component 102, such as a cabinet as shown in FIGS. 1 and 5, may be mounted to slot 56 of track 16 once track assembly 10 is completed as described above. Accessory component 102 includes mounting flange 104 including horizontal flange portion 106 and angled flange portion 108. Track 16 includes relatively narrow slot 56 having horizontal slot section 58 sized to correspond with horizontal flange portion 106, and angled slot section 60 sized to correspond with angled flange portion 108. Mounting flange 104 is inserted into slot 56 of track 16 by inserting angled flange portion 108 of mounting flange 104 into horizontal slot section 58 of slot 56 of track 16 along a direction of arrow B, as shown in FIG. 4A. Angled flange portion 108 is then slid into a seated position within angled slot section 60 of slot 56 of second component by rotating accessory component 102 in the direction of arrow C, as shown in FIG. 4B. As such rotation occurs, horizontal flange portion 106 of accessory component 102 becomes aligned with and is seated within horizontal slot section 58 of slot 56.

Referring to FIG. 6, tile T is shown inserted into tile receiving spaces 74 and 76 of a pair of two-piece track assemblies 10 mounted to substrate 12. Tiles T, which may be decorative or functional tiles for example, have similar upper and lower edges allowing tiles T to be movably mounted and/or attached to track assemblies 10 in either of at least two configurations (e.g., “right-side-up” or “upside-down”). Such mounting is accomplished by tilting tile T at an angle with respect to vertical, as shown in the dashed lines of FIG. 6, and then inserting an upper edge of tile T into lower tile receiving space 76 of an upper track assembly 10. Tile T is then moved upwardly within tile receiving space 76 along direction D while also pivoting tile T to a vertical position as shown by arrow E. The upper edge of tile T is pushed upwardly into tile receiving space 76 sufficiently to allow a lower edge of tile T to clear upper extension 70 of track 16, thereby providing clearance for the final rotation of tile T into the vertical position. The lower edge of tile T is then advanced downwardly along direction F into upper tile receiving space 74 of a lower track assembly 10. When fully seated within tile receiving space 74, as shown in FIG. 6, the lower edge of tile T rests on upper horizontal arm 38 of track 16 of lower track assembly 10.

While this invention has been described as having exemplary designs, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A track assembly, comprising:
a first component mountable to a substrate, said first component comprising:
an exterior face;
an upper portion including upper engagement structure; and
a lower portion including lower engagement structure; and
a second component mountable to said first component, said second component comprising:
a body having a front body portion and a rear body portion;
said front body portion including a slot having a first, horizontal slot section extending into said body from a front face of said front body portion and a second, angled slot section extending into said body from said first slot section; and
said rear body portion including an upper arm and a lower arm, said upper and lower arms respectively engageable with said upper and lower engagement structures of said first component.

2. The track assembly of claim 1, wherein when said second component is mounted to said first component, said second component substantially covers and prevents access to said exterior face of said first component.

3. The track assembly of claim 1, wherein said second slot section is angled upwardly with respect to said first slot section and extends from an end of said first slot section which is disposed opposite said front face of said front body portion.

4. The track assembly of claim 1, wherein said upper engagement structure of said first component is one of a protrusion and a notch and said upper arm of said second component includes the other of said protrusion and said notch.

5. The track assembly of claim 1, wherein said lower engagement structure of said first component comprises one of a protrusion and a notch and said lower arm of said second component comprises the other of said protrusion and said notch.

6. The track assembly of claim 1, wherein said front body portion of said second component further comprises upper and lower extensions wherein, when said second component is mounted to said first component and said first component is mounted to said substrate, said upper and lower extensions of said second component, said respective upper and lower arms of said second component, and said substrate cooperate to define a pair of tile-receiving spaces.

7. The track assembly of claim 1, wherein said first component is configured to mount to the substrate when the substrate is selected from the group consisting of a permanent building wall, a movable office wall, and a movable partition system panel.

8. In combination,
an accessory component comprising a mounting flange including a first, horizontal flange portion and a second, angled flange portion extending from said first flange portion; and
a track assembly, comprising:
a first component mountable to a vertical substrate, said first component comprising:
an exterior face;
an upper portion including an upper engagement structure; and
a lower portion including a lower engagement structure; and
a second component mountable to said first component, said second component comprising:
a body having a front body portion and a rear body portion;
said front body portion including a slot having a first, horizontal slot section extending into said body from a front face of said front body portion and a second, angled slot section extending into said body from said first slot section, said slot sized to receive said mounting flange; and
said rear body portion including an upper arm and a lower arm, said first component mounted to said second component when said upper arm and said lower arm are engaged with said upper and lower engagement structures of said first component, respectively.

9. The combination of claim 8, wherein said second component substantially covers and prevents access to said exterior face of said first component when said second component is mounted to said first component.

10. The combination of claim 8, wherein said second slot section is angled upwardly with respect to said first slot section and extends from an end of said first slot section which is disposed opposite said front face of said front body portion.

11. The combination of claim 8, wherein said upper engagement structure of said first component comprises one of a protrusion and a notch and said upper arm of said second component comprises the other of said protrusion and said notch.

12. The combination of claim 8, wherein said lower engagement structure of said first component comprises one of a protrusion and a notch and said lower arm of said second component comprises the other of said protrusion and said notch.

13. The combination of claim 8, wherein said front body portion of said second component further comprises upper and lower extensions, such that when said second component is mounted to said first component and said first component is mounted to said substrate, said upper and lower extensions of said second component, said respective upper and lower arms of said second component, and said substrate cooperate to define a pair of tile-receiving spaces.

14. The combination of claim 8, wherein said first, horizontal slot section of said slot of said second component is sized to receive said first, horizontal flange portion of said mounting flange and said second, angled slot section of said slot of said second component is sized to receive said second, angled flange portion of said mounting flange.

15. The combination of claim 8, further comprising a vertical substrate selected from the group consisting of a permanent building wall, a movable office wall, and a movable partition system panel.

16. A method of mounting a track assembly to a vertical substrate of an office system, comprising the steps of:
providing a track assembly comprising a first component and a second component;
mounting the first component to the vertical substrate; and
pivotally mounting the second component to the first component.

17. The method of claim 16, wherein said mounting step comprises mounting the first component to at least one of a permanent building wall, a movable office wall, and a movable partition system panel.

18. The method of claim 16, wherein said step of pivotally mounting the second component to the first component comprises:
engaging an upper arm of the second component with an upper engagement structure of an upper portion of the first component;
pivoting the upper arm about the upper portion of the first component; and
engaging a lower arm of the second component with a lower engagement structure of a lower portion of the first component during said pivoting step.

19. The method of claim 16, wherein said step of pivotally mounting the second component to the first component comprises:
engaging a lower arm of the second component with a lower engagement structure of a lower portion of the first component;
pivoting the lower arm about the lower portion of the first component; and
engaging an upper arm of the second component with an upper engagement structure of an upper portion of the first component during said pivoting step.

20. The method of claim 16, wherein said step of pivotally mounting the second component to the first component comprises:
engaging an upper arm of the second component with an upper engagement structure of an upper portion of the first component; and
engaging a lower arm of the second component with a lower engagement structure of a lower portion of the first component, such that the upper and lower arms are substantially horizontal when the upper and lower arms are fully engaged with the upper and lower engagement structures respectively.
